(19) United States
(12) Patent Application Publication
(10) Pub. No.: US 2008/0310760 A1
(43) Pub. Date: Dec. 18, 2008

(54) Method, a System and a Computer Program for Volumetric Registration

(75) Inventors: Ingwer-Curt Carlsen, Hamburg (DE); Thomas Netsch, Eindhoven (NL); Daniel Bystrov, Hamburg (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/092,991

(22) PCT Filed: Nov. 3, 2006
(86) PCT No.: PCT/IB06/54078

§ 371 Date: May 8, 2008

(30) Foreign Application Priority Data
Nov. 14, 2005 (EP) 05110705.0

(51) Int. Cl. G06K 9/32

(52) U.S. Cl. 382/294

(57) ABSTRACT

The invention relates to a method for volumetric registration of a floating image with a reference image. At step 2′ a floating image and a reference image are accessed. At step 4 and at step 6 a transformation function T and a similarity function (S) are accessed. The method according to the invention uses a-priori knowledge, notably a restricted parameter set, which is accessed at step 3. Preferably, the restricted parameter set is obtained by performing a suitable volumetric registration of a set of training images. The training set preferably comprises a sequence of floating images and reference images for each clinical application. Likewise, the training set may be composed of images of a patient group representing a certain group of disease, age, gender, race, etc. The invention further relates to a system and a computer program for enabling volumetric registration.

The invention relates to a method for volumetric registration of a floating image with a reference image, comprising the steps of:

accessing the floating image and the reference image;

selecting a parameterized geometric transformation function for spatially warping the floating image;

selecting a similarity function for quantitatively estimating a similarity between a warped floating image and the reference image.

The invention further relates to a system for volumetric registration of a floating image with a reference image.

The invention still further relates to a computer program for volumetric image registration of a floating image with a reference image comprising instructions to cause a processor to carry out the following steps:

accessing the floating image and the reference image;

selecting a parameterized geometric transformation function for spatially warping the floating image;

selecting a similarity function for quantitatively estimating a similarity between a warped floating image and the reference image.

Registration methods are known per se, for example in form of a surface-based approach from U.S. Pat. No. 5,633,951. An embodiment of the method as is set forth in the opening paragraph is known from article “Adaptive Search Space Scaling in Digital Image Registration”, Venkat R. Mandava et al, IEEE Transactions on Medical Imaging, Vol. 8, No. 3, September 1989. The known method is arranged to carry out volumetric registration of images by means of warping a floating image prior to finding a proper geometrical match of it with a reference image. In the known method in order to make search space pruning feasible the search space is discretized into N-dimensional hyper cubes. Optimization methods, like genetic algorithms or simulated annealing are used for searching of an optimum, notably the global maximum, of a similarity function representing the quality of geometrical match between a warped floating image and a reference image during registration. In the known method these optimization algorithms are used for volumetric registration when the reduced search space is chosen by a human operator based on certain a-priori information about the complexity of motion artifacts. Alternatively, the known method is arranged to enable an adaptive search space scaling, whereby the human operator has to initially define a region of interest.

It is a disadvantage of the known method that a great number of parameters have to be adjusted leading to a multi-dimensionality of the search space of the optimization algorithm. This multi-dimensionality correlates with a number of local optima, which may trap the optimization algorithm and prevent it from finding a global optimum, thus reducing quality of the volumetric registration.

It is an object of the invention to provide a method for volumetric registration which is reliable and robust.

To this end the method according to the invention comprises the following steps:

selecting a restricted parameter set for the parameterized geometric transformation function based on an a-priori knowledge;

spatially warping the floating image using the parameterized geometric transformation function with the restricted parameter set yielding a warped floating image;

optimizing the restricted parameter set for locating an optimum of the similarity function.

The method according to the invention is based on the insight that optimization methods present an efficient tool to locate a global optimum, notably a maximum, of the similarity function over the parameter space, and their performance in terms of speed and robustness depends on the definition of the search space and the contraction strategy. It is understood that an increasing number of parameters increases the flexibility of the warping transformation, but also increases the search space that has to be explored thus leading to an increasing number of local optima that may prevent the optimization algorithm from reaching the global optimum. The restricted parameter set prunes the parameter set to those parameters that are essential for locating the global optimum. This pruning is based on the a-priori knowledge, deduced from a set of training images representative of the floating image and the reference image.

In an embodiment of the method according to the invention the restricted parameter set is obtained by analyzing results of a volumetric registration of training images representative of the floating image and the reference image, said volumetric registration being performed using the parameterized geometric transformation function with an enlarged parameter set.

The training set preferably comprises a sequence of floating images and reference images for each clinical application. For example, one may successfully perform volumetric registration for a certain anatomical site or for a certain type of pathology. Likewise, the training set may be composed of images of a patient group representing a certain group of disease, age, gender, race, etc. All possible combinations of the above categories are contemplated as well. In accordance with the method of the invention the prior knowledge is deduced from a-priori prepared training sets.

Due to this technical measure the following advantageous effect is reached—the optimization algorithm, notably a stochastic search strategy or a randomly restarted deterministic optimization method, is automatically tuned to locate the global optimum of the similarity function that corresponds to the type of images under consideration. A set of k training images, representative of the target application, for example medical images of a certain anatomical site, is beforehand registered using a computationally intensive registration algorithm using a parameterized geometric transformation function with enlarged parameter set. The geometric transformation function may be constructed based, for example, on parameterized motion models characteristic of the application area. Preferably, this operation is performed automatically. The resulting enlarged parameter set (p₁ . . . pₙ) is subjected, for example, to a principal component analysis (PCA) leading to a restricted set of parameters Q=(q₁ . . . qₘ), defining a new parameterization of the search space, whereby, preferably, m<n. In this way the new restricted parameter set Q is sufficient to approximate the most relevant deformation patterns for the registration of the initial training set with sufficient accuracy. The set Q thus defines the primary search directions guiding the optimization algorithm through a low-dimensional sub-space towards the global optimum. Thus, when the most important parameters from the enlarged parameter set of the training images are obtained, these parameters are used for the geometric transformation function of a clinical registration from the same class of images as the training set. For example, an application “brain” will use the restricted parameter set from the training set “brain”, and so on. The optimization function will then optimize the restricted parameter set, thus being more effective and accurate. For the optimization algorithm any locally or globally converging optimization method is suitable. When a stochastic optimization method is selected, which is known per se in the art, an additional advantage is reached, namely the restricted parameters set provides a strategy that drives the search towards the global optimum. As an additional advantage, the probability distribution of the deformation patterns over the search space can be estimated from the training set. Projecting this distribution onto the subspace spanned by Q provides the marginal distributions of the most relevant deformation patterns that can be used to determine the optimal sampling strategy along sub-space search directions provided by Q. Therefore, the parameterization Q further improves the performance of the method according to the invention operating in reduced space dimensions, by better delimiting the search space and, when applied with stochastic optimization algorithms, by improving the optimal density distribution for the stochastic sampling strategy.

In a further embodiment of the method according to the invention the restricted parameter set is obtained based on a feature deduced from the analysis of the enlarged parameter set.

Suitable examples of the feature comprise a reduced number of parameters, a reduced number of coordinate axes, allowable ranges of the respective parameters, a density distribution of the parameters.

In a still further embodiment of the method according to the invention the method further comprising the steps of:

detecting a substantial deviation in the feature;

updating the prior knowledge;

deducing updated restricted parameter set from updated prior knowledge.

The method according to the invention is advantageously self-adapting. In accordance with this technical measure the volumetric registration method is capable of automatically tracking and signaling sufficient changes in the deformation patterns of the floating image. In case the selected training set is no longer representative of the clinical case, a signal of a substantial deviation is used to update the a-priori knowledge by compiling a new up to date training set, subjecting it to a suitable sophisticated volumetric registration technique, and deducing an updated restricted parameter set, which can be used for more accurately registering the clinical cases.

In a still further embodiment of the method according to the invention the method further comprises the steps of:

using the prior knowledge for estimating an expected probability distribution in a deformation pattern of the floating image over the sub-space;

determining a sampling strategy for the optimization function within the sub-space from said estimation.

As has been explained earlier, the restricted parameter set (q₁ . . . qₘ) defines primary search directions guiding the optimization algorithm, notably a stochastic optimization, through a low-dimensional sub-space towards a global optimum. In addition, the probability distribution of the deformation patterns over the search space can be estimated from the training set yielding additional prior knowledge. By projecting this distribution onto the sub-space (q₁ . . . qₘ) provides marginal distributions of the most relevant deformation patterns that can be used to determine the optimal sampling strategy along sub-space search directions provided by (q₁ . . . qₘ).

A system according to the invention comprises:

an input for:

accessing the floating image and the reference image;

selecting a parameterized geometric transformation function for spatially warping the floating image;

selecting a similarity function for quantitatively estimating a similarity between a warped floating image and the reference image;

selecting a restricted parameter set for the parameterized geometric transformation function based on an a-priori knowledge;

processing means for:

spatially warping the floating image using the parameterized geometric transformation function with restricted parameter set yielding a warped floating image;

optimizing the restricted parameter set for locating an optimum of the similarity function.

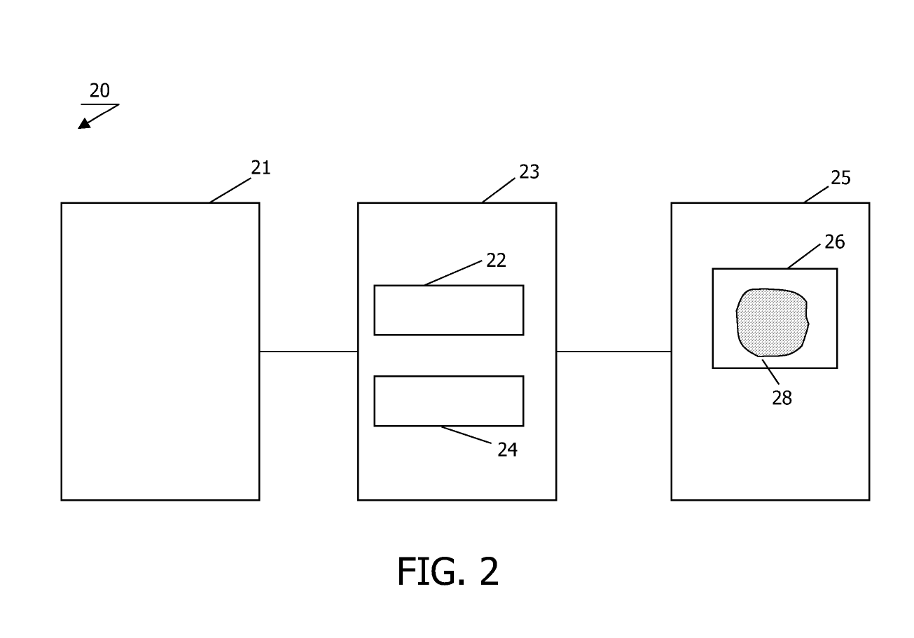

The system according to the invention advantageously enables a volumetric registration of images whereby an a-priori knowledge is used. Preferably, the restricted parameter set is obtained by the processing means by analyzing results of a volumetric registration of training images representative of the floating image and the reference image, said volumetric registration being performed using the parameterized geometric transformation function with an enlarged parameter set. The training set preferably comprises a sequence of floating images and reference images for each clinical application. For example, one may successfully perform volumetric registration for a certain anatomical site or for a certain type of pathology. Likewise, the training set may be composed of images of a patient group representing a certain group of disease, age, gender, race, etc. All possible combinations of the above categories are contemplated as well. Still preferably, the processing means of the system according to the invention is further arranged to obtain the restricted parameter set based on a feature deduced from the analysis of the enlarged parameter set. Examples of suitable feature comprise a reduced number of parameters, an allowable range of the respective parameter, a density distribution of the parameters. Still preferably, the processing means of the system according to the invention is still further arranged to detect a substantial deviation in the feature; to updating the a-priori knowledge and to deducing updated restricted parameter sets from updated a-priori knowledge. In this way a self-learning system is provided, whereby the training set is updated based on a consistency of its representation to the actual data. Further advantages of the system according to the invention will be discussed in FIG. 2.

A computer program according to the invention comprises instructions to cause the processor to carry out the further steps of:

selecting a restricted parameter set for the parameterized geometric transformation function based on an a-priori knowledge;

spatially warping the floating image using the parameterized geometric transformation function with restricted parameter set yielding a warped floating image;

optimizing the restricted parameter set for locating an optimum of the similarity function.

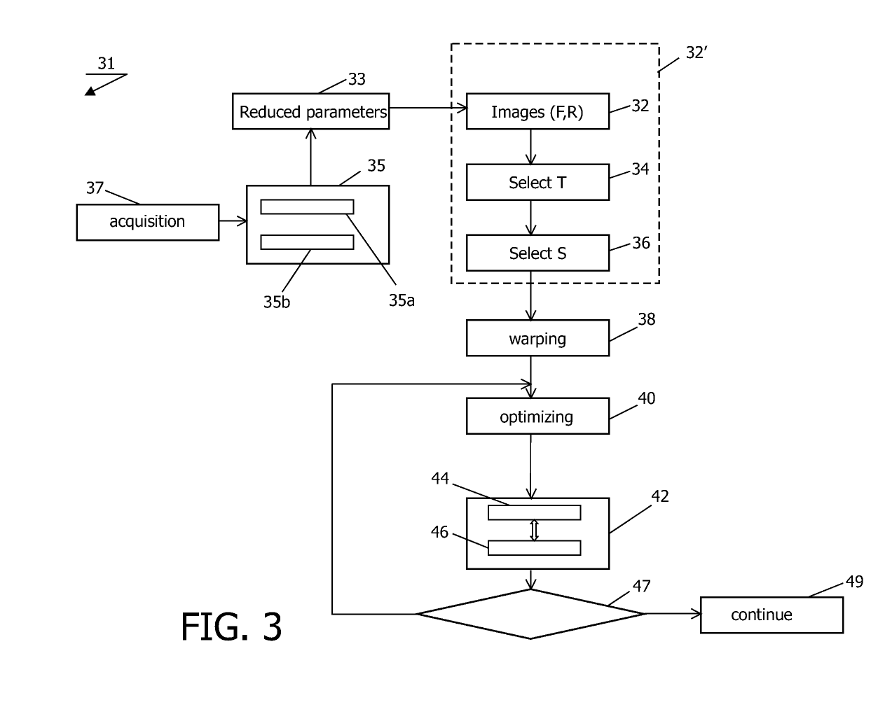

In accordance with the computer program of the invention an improved volumetric registration is enabled whereby the a-priori knowledge preferably comprises analysis of results of a volumetric registration of training images representative of the floating image and the reference image, said volumetric registration being performed using the parameterized geometric transformation function with an enlarged parameter set. Further advantageous embodiments of the system according to the invention are given in claims 13-15. The operation of the computer program according to the invention will be discussed in more detail with reference to FIG. 3.

These and other details of the invention will be discussed in further detail with reference to Figures.

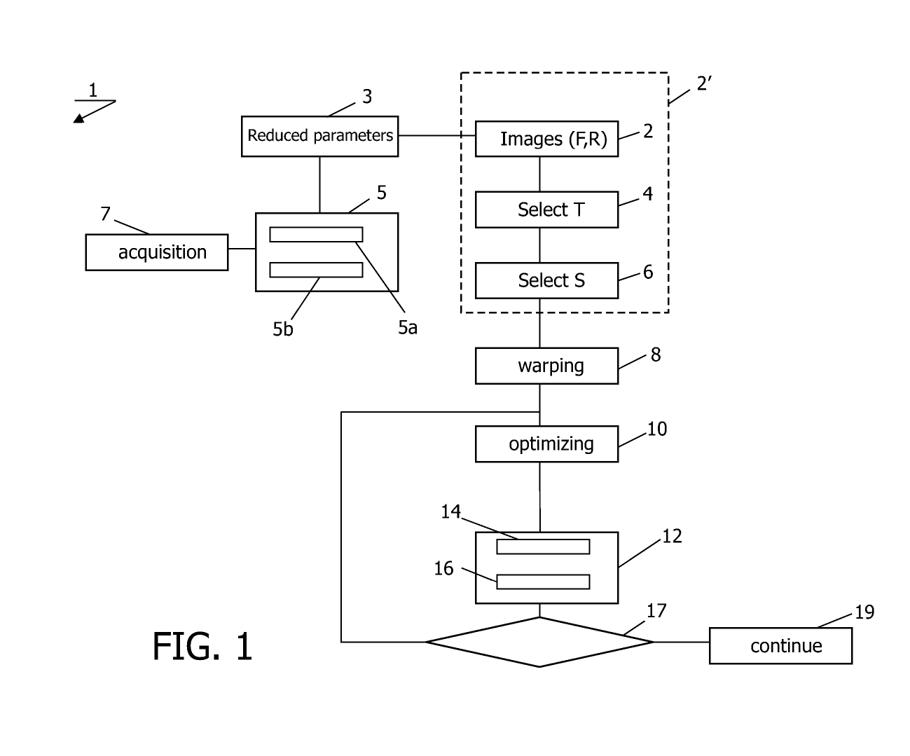

FIG. 1 presents in a schematic way an embodiment of a block-scheme of the method according to the invention.

FIG. 2 presents in a schematic way an embodiment of a system according to the invention.

FIG. 3 presents in a schematic way an embodiment of a flow-chart of the computer program according to the invention.

FIG. 1 presents in a schematic way an embodiment of a block-scheme of the method according to the invention. At step 2′ of the method 1 according to the invention input operations are carried out. Thus, at step 2 floating image and reference image conceived to be volumetrically registered are loaded. At step 4 a transformation function T for spatially warping the floating image (F) is accessed. At step 6 a similarity function (S) for quantitatively estimating a similarity between a warped floating image (F′) and the reference image (R) is accessed. The method according to the invention uses a-priori knowledge, notably a restricted parameter set, which is accessed at step 3. Preferably, the restricted parameter set is obtained by performing a suitable volumetric registration of a set of training images. The training set preferably comprises a sequence of floating images and reference images for each clinical application. For example, one may successfully perform volumetric registration for a certain anatomical site or for a certain type of pathology. Likewise, the training set may be composed of images of a patient group representing a certain group of disease, age, gender, race, etc. All possible combinations of the above categories are contemplated as well. In accordance with the method of the invention the prior knowledge is deduced from a-priori prepared training sets.

Due to this technical measure the following advantageous effect is reached—the optimization algorithm, notably a stochastic search strategy or a randomly restarted deterministic optimization method, is automatically tuned to locate the global optimum of the similarity function that corresponds to the type of images under consideration. A set of k training images, representative of the target application, for example medical images of a certain anatomical site, is beforehand registered using a computationally intensive registration algorithm using a parameterized geometric transformation function with enlarged parameter set. The geometric transformation function may be constructed based, for example, on parameterized motion models characteristic of the application area. Preferably, this operation is performed automatically. The resulting enlarged parameter set (p₁ . . . pₙ) is subjected, for example, to a principal component analysis (PCA) leading to a restricted set of parameters Q=(q₁ . . . qₘ), defining a new parameterization of the search space, whereby, preferably, m<n. In this way the new restricted parameter set Q is sufficient to approximate the most relevant deformation patterns for the registration of the initial training set with sufficient accuracy. The set Q thus defines the primary search directions guiding the optimization algorithm through a low-dimensional sub-space towards the global optimum. Thus, when the most important parameters from the enlarged parameter set of the training images are obtained, these parameters are used for the geometric transformation function of a clinical registration from the same class of images as the training set. For example, an application “brain” will use the restricted parameter set from the training set “brain”, and so on. The optimization function will then optimize the restricted parameter set, thus being more effective and accurate. Preferably, the training images are acquired at step 7 using the same data acquisition unit as for the floating and reference images.

The method 1 according to the invention operates as follows. At step 8 the floating image (F) is warped using the transformation function with the restricted parameter set, obtained at step 3. At step 10 the restricted parameter set is being optimized for purpose of locating a global optimum in the similarity function 12, which estimates a degree of similarity between the warped floating image 14 and the reference image 16. In case this degree of similarity meets a quality criterion, the optimization is stopped at step 17 and the method proceeds to a following step 19. Otherwise, the restricted parameter set is optimized further at step 10 and the loop 10-12-17 continues. For the optimization algorithm any locally or globally converging optimization method is suitable. When a stochastic optimization method is selected, which is known per se in the art, an additional advantage is reached, namely the restricted parameters set provides a strategy that drives the search towards the global optimum. As an additional advantage, the probability distribution of the deformation patterns over the search space can be estimated from the training set. Projecting this distribution onto the subspace spanned by Q provides the marginal distributions of the most relevant deformation patterns that can be used to determine the optimal sampling strategy along sub-space search directions provided by Q. Therefore, the parameterization Q further improves the performance of the method according to the invention operating in reduced space dimensions, by better delimiting the search space and, when applied with stochastic optimization algorithms, by improving the optimal density distribution for the stochastic sampling strategy.

FIG. 2 presents in a schematic way an embodiment of a system according to the invention. The system 20 according to the invention comprises a computer 23 with an input 22 arranged to access the floating image, the reference image and the restricted parameter set (not shown), which is obtained in accordance with the method discussed with reference to FIG. 1. The input 22 is further arranged to access a parameterized geometric transformation function for spatially warping the floating image. The input 22 is still further arranged to access a similarity function for quantitatively estimating a similarity between a warped input image and the reference image. The input 22 is still further arranged to access a suitable optimization algorithm for locating the global optimum of the similarity function over the restricted parameter set. The computer 23 of the system 20 according to the invention further comprises a computer means 24 arranged to optimize the restricted parameter set for locating the global optimum of the similarity function. The operation of the system according to the invention is preferably controlled by a computer program comprising instructions to cause a processor 26 to carry out the steps of the method 1 as is discussed with reference to FIG. 1. The system 20 according to the invention still preferably comprises a data acquisition unit 21 arranged for acquiring at least reference images. Suitable examples of the data acquisition unit comprise an MR-unit, a CT- or X-ray unit, an ultra-sonic apparatus, etc. The system 20 still further preferably comprises a viewer 25 arranged to display result of volumetric registration 28 projected on a suitable display 28. It is possible that the data acquisition unit 21, the computer 23 and the display unit 15 are located substantially remotely from each other. In this case they are preferably connected by means of a data transmission link, like an internet or by means of a suitable wireless data communication.

FIG. 3 presents in a schematic way an embodiment of a flow-chart of the computer program according to the invention. In accordance with instruction 32′ of the computer program 31 according to the invention input operations are carried out. Thus, instruction 32 causes a processor (not shown) to load a floating image and a reference image conceived to be volumetrically registered. In accordance with instruction 34 a transformation function T for spatially warping the floating image (F) is accessed, and in accordance with instruction 36 a similarity function (S) for quantitatively estimating a similarity between a warped floating image (F′) and the reference image (R) is accessed. The computer program according to the invention uses a-priori knowledge, notably a restricted parameter set, which is accessed in accordance with instruction 33. Preferably, the restricted parameter set is obtained by performing a suitable volumetric registration of a set of training images. The training set preferably comprises a sequence of floating images and reference images for each clinical application. For example, one may successfully perform volumetric registration for a certain anatomical site or for a certain type of pathology. Likewise, the training set may be composed of images of a patient group representing a certain group of disease, age, gender, race, etc. All possible combinations of the above categories are contemplated as well. In accordance with the computer program of the invention the a-priori knowledge is deduced from a-priori prepared training sets.

Due to this technical measure the following advantageous effect is reached—the optimization algorithm, notably a stochastic search strategy or a randomly restarted deterministic optimization method, is automatically tuned to locate the global optimum of the similarity function that corresponds to the type of images under consideration. A set of k training images, representative of the target application, for example medical images of a certain anatomical site, is beforehand registered using a computationally intensive registration algorithm using a parameterized geometric transformation function with enlarged parameter set. The geometric transformation function may be constructed based, for example, on parameterized motion models characteristic of the application area. Preferably, this operation is performed automatically. The resulting enlarged parameter set (p₁ . . . pₙ) is subjected, for example, to a principal component analysis (PCA) leading to a restricted set of parameters Q=(q₁ . . . qₘ), defining a new parameterization of the search space, whereby, preferably, m<n. In this way the new restricted parameter set Q is sufficient to approximate the most relevant deformation patterns for the registration of the initial training set with sufficient accuracy. The set Q thus defines the primary search directions guiding the optimization algorithm through a low-dimensional sub-space towards the global optimum. Thus, when the most important parameters from the enlarged parameter set of the training images are obtained, these parameters are used for the geometric transformation function of a clinical registration from the same class of images as the training set. For example, an application “brain” will use the restricted parameter set from the training set “brain”, and so on. The optimization function will then optimize the restricted parameter set, thus being more effective and accurate. Preferably, the training images are acquired pursuant instruction 37 using the same data acquisition unit as for the floating and reference images.

The computer program 31 according to the invention operates as follows. Instruction 38 warps the floating image (F) using the transformation function with the restricted parameter set, obtained due to instruction 33. Instruction 40 causes the processor (not shown) to optimize the restricted parameter set for purpose of locating a global optimum in the similarity function 42, which estimates a degree of similarity between the warped floating image 44 and the reference image 46. In case this degree of similarity meets a quality criterion, the optimization is stopped in accordance with instruction 47 and the computer program proceeds to a following instruction 49. Otherwise, the restricted parameter set is optimized further by returning to instruction 40 and the loop 40-42-47 continues. For the optimization algorithm any locally or globally converging optimization method is suitable. When a stochastic optimization method is selected, which is known per se in the art, an additional advantage is reached, namely the restricted parameters set provides a strategy that drives the search towards the global optimum. As an additional advantage, the probability distribution of the deformation patterns over the search space can be estimated from the training set. Projecting this distribution onto the subspace spanned by Q provides the marginal distributions of the most relevant deformation patterns that can be used to determine the optimal sampling strategy along sub-space search directions provided by Q. Therefore, the parameterization Q further improves the performance of the volumetric registration method by operating in reduced space dimensions, thus better delimiting the search space and, when applied with stochastic optimization algorithms, by improving the optimal density distribution for the stochastic sampling strategy.

1. A method for volumetric registration of a floating image (F) with a reference image (R), comprising the steps of:
accessing the floating image (F) and the reference image (R);
selecting a parameterized geometric transformation function (T(p₁ . . . pₙ)) for spatially warping the floating image (F);
selecting a similarity function (S) for quantitatively estimating a similarity between a warped floating image (F′) and the reference image (R);
selecting a restricted parameter set for the parameterized geometric transformation function (T(q₁ . . . qₘ with m<n)) based on an a-priori knowledge;
spatially warping the floating image using the parameterized geometric transformation function (T(q₁ . . . qₘ)) with restricted parameter set (q₁ . . . qₘ) yielding a warped floating image (F′);
optimizing the restricted parameter set (q₁ . . . qₘ) for locating an optimum of the similarity function (S).

2. A method according to claim 1, whereby the restricted parameter set (q₁ . . . qₘ) is obtained by analyzing results of a volumetric registration of training images representative of the floating image (F) and the reference image (R), said volumetric registration being performed using the parameterized geometric transformation function with an enlarged parameter set (p₁ . . . pₙ).

3. A method according to claim 2, whereby the restricted parameter set (q₁ . . . qₘ) is obtained based on a feature deduced from the analysis of the enlarged parameter set.

4. A method according to claim 3, whereby the feature comprises a reduced number of parameters.

5. A method according to claim 3, whereby the feature comprises a reduced number of coordinate axes.

6. A method according to claim 3, whereby the feature comprises an allowable range of the respective parameters.

7. A method according to claim 3, whereby the feature comprises a density distribution of the parameters.

8. A method according to claim 4, said method further comprising the steps of:
detecting a substantial deviation in the feature;
updating the a-priori knowledge;
deducing updated restricted parameter sets from updated a-priori knowledge.

9. A method according to claim 1, whereby the method further comprises the steps of:
using the a-priori knowledge for estimating an expected probability distribution in deformation patterns of the floating image over the sub-space (q₁ . . . qₘ);
determining a sampling strategy for the optimization function within the sub-space (q₁ . . . qₘ) from said estimation.

10. A system for volumetric registration of a floating image (F) with a reference image (R), said system comprising:
an input for:
accessing the floating image (F) and the reference image (R);
selecting a parameterized geometric transformation function (T(p₁ . . . pₙ)) for spatially warping the floating image (F);
selecting a similarity function (S) for quantitatively estimating a similarity between a warped floating image (F′) and the reference image (R);
selecting a restricted parameter set for the parameterized geometric transformation function (T(q₁ . . . qₘ with m<n)) based on an a-priori knowledge;
processing means for:
spatially warping the floating image using the parameterized geometric transformation function (T(q₁ . . . qₘ)) with restricted parameter set (q₁ . . . qₘ) yielding a warped floating image (F′);
optimizing the restricted parameter set (q₁ . . . qₘ) for locating an optimum of the similarity function (S).

11. A system according to claim 10, whereby the system further comprises a data acquisition unit arranged to acquire at least the reference image.

12. A computer program for volumetric registration of a floating image (F) with a reference image (R) comprising instructions for causing a processor to carry out the following steps:
accessing the floating image (F) and the reference image (R);
selecting a parameterized geometric transformation function (T(p₁ . . . pₙ)) for spatially warping the floating image (F);
selecting a similarity function (S) for quantitatively estimating a similarity between a warped floating image (F′) and the reference image (R);
selecting a restricted parameter set for the parameterized geometric transformation function (T(q₁ . . . qₘ with m<n)) based on an a-priori knowledge;
spatially warping the floating image using the parameterized geometric transformation function (T(q₁ . . . qₘ)) with restricted parameter set (q₁ . . . qₘ) yielding a warped floating image (F′);
optimizing the restricted parameter set (q₁ . . . qₘ) for locating an optimum of the similarity function (S).

13. A computer program according to claim 12, further comprising instructions for causing the processor to carry out the steps of:
obtaining the restricted parameter set based on a feature deduced from the analysis of an enlarged parameter set.

14. A computer program according to claim 13, whereby the computer program comprises further instructions to cause the processor to carry out the steps of:
detecting a substantial deviation in the feature;
updating the a-priori knowledge;
deducing updated restricted parameter sets from updated a-priori knowledge.

15. A computer program according to claim 12, further comprising instructions to cause the processor to carry out the steps of:
using the a-priori knowledge for estimating an expected probability distribution in deformation patterns of the floating image over the sub-space (q₁ . . . qₘ);
determining a sampling strategy for the optimization function within the sub-space (q₁ . . . qₘ) from said estimation.
